(19) United States
(12) Patent Application Publication
(10) Pub. No.: US 2014/0052479 A1
(43) Pub. Date: Feb. 20, 2014

(54) ESTIMATING INSURANCE RISKS AND COSTS

(71) Applicant: Tetsu Kawamura, Naha-shi (JP)

(72) Inventor: Tetsu Kawamura, Naha-shi (JP)

(73) Assignee: EMPIRE TECHNOLOGY DEVELOPMENT LLC, Wilmington, DE (US)

(21) Appl. No.: 13/809,236

(22) PCT Filed: Aug. 15, 2012
(86) PCT No.: PCT/US12/50937

§ 371 Date: Jan. 9, 2013

(51) Int. Cl. G06Q 40/08

(52) U.S. Cl. CPC G06Q 40/08
USPC 705/4

(57) ABSTRACT

In some examples, a method for estimating insurance risk is described. The method may include receiving, by a processor, real-time information related to a travel itinerary. The method may also include estimating, by the processor, the insurance risk by analyzing the real-time information based on a quantitative assessment of risks posed to a population by the at least one factor. The method may also include generating, by the processor, an insurance risk profile based on the estimated insurance risk

### BACKGROUND

Unless otherwise indicated herein, the materials described herein are not prior art to the claims in the present application and are not admitted to be prior art by inclusion in this section.

Travel insurance is short-term insurance taken by those who travel abroad, which covers certain losses, such as, cancelation of trips, airport delays, loss of belongings, emergency medical costs, and personal liabilities. Conventional travel insurance is typically calculated by analyzing a number of factors including the specific location being visited, the length and nature of travel and the activities planned. However, these factors are static and fees are fixed rate.

### SUMMARY

Techniques described herein generally relate to estimating travel insurance risks and costs.

In some examples, a method for estimating insurance risk is described. The method may include receiving, by a processor, real-time information related to a travel itinerary. The method may also include estimating, by the processor, the insurance risk by analyzing the real-time information based on a quantitative assessment of risks posed to a population by the at least one factor. The method may also include generating, by the processor, an insurance risk profile based on the estimated insurance risk.

In some examples, a method for estimating insurance cost is described. The method may include creating, by a processor, multiple data sets from real-time information corresponding to a risk factor relevant in determining travel insurance. The real-time information may be obtained via at least one source of the real-time information. The method may also include storing statistical data relating to a probability of an insurance claim based on the risk factor. The method may also include estimating, by the processor, an insurance risk based on the multiple data sets by comparing the real-time information of each data set with the statistical data. The method may also include rendering a cost estimate to obtain an insurance policy based on the estimated insurance risk. The method may also include generating an electronic message including the cost estimate to obtain the insurance policy.

In some examples, a method for determining insurance cost is described. The method may include receiving real-time information from at least one of a global positioning system, a sensor, a radio-broadcast clock, a radio-frequency identification device, a portable electronic device, a vehicle information and communication system and a local area network. The method may also include compiling, by a processor, at least one data set that includes data selected from the real-time information. The data may be related to at least one risk factor relevant in determining travel insurance risk. The method may also include comparing, by the processor, the at least one data set with statistical data corresponding to the at least one risk factor to determine an insurance risk using an algorithm. The method may also include rendering an insurance cost estimate based on the insurance risk. The method may also include performing, by the processor, at least one of altering the cost estimate in response to at least one change in the real-time information and analyzing the insurance risk to determine at least one modification to the real-time information that reduces the cost estimate.

In some examples, a system configured to generate a cost of insurance is described. The system may include a database having a computer program stored thereon and a processor. The processor may be configured to receive real-time information related to a travel itinerary of an individual, to compare the data with statistical data corresponding to the at least one factor to determine an insurance risk using the computer program and to determine a cost of an insurance policy for the individual based on the insurance risk. The information received by the processor may include data representative of at least one factor indicative of the insurance risk.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

In the drawings:

FIG. 1 is a block diagram illustrating an embodiment of system configured to estimate insurance risks and costs based on monitoring of real-time information;

FIG. 2 is a block diagram illustrating another embodiment of a system configured to estimate insurance risks and costs based on monitoring of real-time information;

FIG. 3A shows an example flow diagram of a method for estimating an insurance risk;

FIG. 3B shows an example flow diagram of a method for estimating an insurance cost;

FIG. 3C shows an example flow diagram of a method for determining an insurance cost; and

FIG. 4 is a block diagram illustrating an example computing device that is arranged for estimating insurance risks and costs,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Some embodiments disclosed herein generally relate to estimating insurance risks and costs from real-time information. As used herein, the term “real-time information” may refer to information or data collected at the time an event occurs or soon after the event occurs. The real-time information may include data related to at least one factor relevant in determining insurance risks and insurance costs. The real-time information may be collected from at least one source, such as, but not limited to, a mobile device, a temperature sensor, a barometer, an altimeter, a visible light sensor, a global positioning system (GPS), a radio beacon or broadcast clock, a wireless local area network (WLAN) station, a vehicle information and communication system (VICS) or traffic information broadcast system, a radio-frequency identification (RFID) system and a vehicle tracking and telemetry system. For example, the mobile device (e.g., a mobile telephone, a personal digital assistant (PDA), a laptop computer or a tablet computer) may receive the real-time information.

The real-time information may be received by a system configured to estimate insurance risk and to determine insurance rates through a communication network. The communication network may include, for example, a telecommunications network, a global network, a national network, a local network, a local area network (LAN), a wide area network (WAN), a personal area network (PAN), a wireless local area network (WLAN), and/or a wireless personal area network (WPAN).

The insurance risk may be determined by analyzing the real-time information based on a quantitative assessment of risks posed to a population by the at least one factor relevant in determining travel insurance risks. In these and other embodiments, an algorithm for analyzing the real-time information to determine insurance risks and/or costs may be provided. The algorithm may be a function of the at least one factor relevant in determining insurance risks and insurance costs. The at least one factor may include, but is not limited to, a country, a location, a time of day, a season, weather, a mode of transportation, road conditions, local population density, historical data concerning safety, crime, accidents, etc.

The insurance risk may be analyzed to generate an insurance policy based on the real-time data and a cost of the insurance policy may be determined by correlating the insurance risk with information related to insurance costs. The cost of the insurance policy may be generated as a one-time fee or, alternatively, as an annual or periodic subscription fee which is assessed on a pre-determined time interval (e.g., weekly, monthly, annually, etc.).

The real-time information may also be used to generate modifications to the insurance policy or to determine ad hoc options while en route during at least one travel schedule. For example, an alternate route or schedule may be determined that results in a reduced risk and, therefore, a reduced cost of the insurance policy. In addition, the insurance cost may be determined based on specific details of the travel itinerary, which may be altered based on the course of travel.

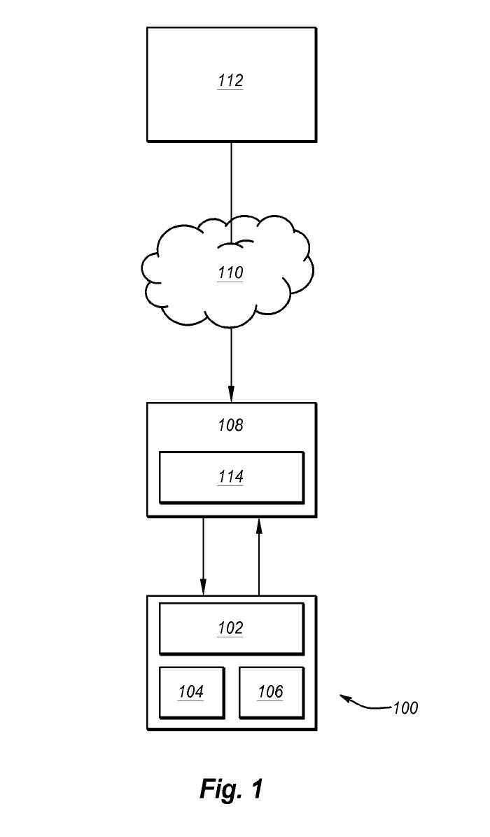

FIG. 1 is a block diagram illustrating an embodiment of a system 100 configured to estimate insurance risks and costs based on monitoring of real-time information, arranged in accordance with at least some embodiments described herein. The real-time information may include information related to determination of a travel insurance policy based on a travel itinerary. As used herein, the term “itinerary” may refer to a plan for travel to one or more locations, the details of which may include, for example, a list of places to visit or visited, a route of travel, a mode of travel, etc. By way of example and not limitation, the travel insurance policy may cover at least one of medical and dental expenses, emergency evacuation, trip cancelation or delays, death or injury, life, theft, damage loss, or theft of belongings, delayed baggage and automobile accidents. The system 100 may be configured to track the real-time information based on the travel itinerary. The system 100 may also be configured to determine alterations in the relevant real-time information resulting from changes to the travel itinerary.

For example, the real-time information may include information relevant to estimating an insurance risk. The real-time information may include, for example, information related to at least one of location, time, date, duration, season, weather, population density, route, transportation mode, or planned activities. For example, the real-time information related to location may include data obtained from a particular location, such as, weather, political or social activities or events, natural disasters, security risks and traffic conditions. Information related to the mode of transportation may include, for example, vehicle type, route, speed, road conditions and distance traveled.

The system 100 may include a means for processing electronic data, such as a processor 102, a means for storing information readable and accessible by the processor 102, such as a database 104, and a means for communicating with the Internet or a computer network, such as a communications module 106. The system 100 may include software, such as an operating system, and other peripheral devices for performing the functions described herein.

The processor 102 may be any device capable of executing a set of instructions that specify actions to be taken. For example, the processor 102 may include a central processing unit (CPU). The processor 102 may be in communication with the database 104.

The database 104 may be implemented in a computer-readable medium and may include an organized collection of data that can be used as described herein. The computer-readable medium in which the database 104 is implemented may alternately or additionally include a computer-readable code (e.g., software) including a set of instructions that are executed by the processor 102 to perform one or more of the acts or operations associated with the methods described herein.

The computer-readable medium may be any available media that may be accessed by a general purpose or special purpose computer. By way of example, and not limitation, such computer-readable media may include random access memory (RAM), read only memory (ROM), electrically erasable programmable read only memory (EEPROM), compact disc-ROM (CD-ROM) or other optical disk storage, magnetic disk storage or other magnetic storage devices, flash memory or other solid state storage devices, or any other medium which may be used to carry or store desired program code means in the form of computer-executable instructions.

The computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing acts and/or operations of the methods disclosed herein. The particular sequence of such executable instructions or associated data structures represents examples of corresponding acts for implementing the functions described therein.

The computer-readable medium may be included, for example, in the system 100 where it may be accessed by the processor 102. The computer-readable medium may be used to store, for example, statistical data relating to a probability of an insurance claim based on a risk factor or risk factors (hereinafter “risk factor(s)”) relevant in determining travel insurance. The risk factor(s) may include, for example, a location, a travel season, a travel time, a travel date, a travel route, a travel speed, travel activity, weather, vehicle type, vehicle condition, traffic accident rate, traffic conditions, local population density, local transportation, altitude, and transportation mode.

The system 100 may utilize the communications module 106 to enable communication between the processor 102 and the Internet or another computer network. The communications module 106 may include, for example, a modem, an ethernet card, a universal serial bus (USB) interface card, a WLAN interface or any other network interface device.

The processor 102 may be configured to receive the real-time information transmitted through at least one communication network 110. For example, the processor 102 may receive the real-time information via the communications module 106. The real-time information may include any information capable of being collected through the communication network 110. The communication network 110 from which the real-time information is obtained may include, for example, a telecommunications network, a global network, a national network, a local network, a LAN, a WAN, a PAN, a WLAN and/or a WPAN.

The real-time information may be collected by at least one source of information 112. The source of information 112 may be configured to transmit real-time information over the communication network 110 and the communication network 110 may be configured to transfer the real-time information from the source of information 112 to a mobile device 108. The source of information 112 may include, but is not limited to, a sensor, a positioning system, a content provider or an RFID reader. By way of example and not limitation, the source of information 112 may include a sensor configured to determine at least one of temperature, humidity, pressure, altitude and visible light. Examples of sensors include, but are not limited to, a temperature gauge, a thermocouple, a thermistor, a barometer, an altimeter, a charge coupled device (CCD), an ambient light sensor, a photocell, a photodetector, a speedometer and an accelerometer. By way of example and not limitation, the source of information 112 may include a positioning system configured to acquire positioning Examples of positioning systems include, but are not limited to, a GPS unit, a navigation unit, a WLAN station and a radio clock or beacon. By way of example and not limitation, the content provider may include, for example, a VICS service or a traffic information broadcast service. The source of information 112 may alternately or additionally include a base station associated with a wireless telephone network.

The source of information 112 may be configured to transmit real-time information over the communication network 110 and the communication network 110 may be configured to transfer the real-time information from the source of information 112 to the mobile device 108. The mobile device 108 may include, for example, a mobile telephone, a tablet or laptop computer, a PDA, a GPS or navigation unit, a toll box or an emergency remote.

In some embodiments, the system 100 may be configured to receive the real-time information directly from the source of information 112. In such an embodiment, the real-time information may be collected by the source of information 112 and may then be transmitted by the communication network 110 to the system 100, where it may be received, for example, by the processor 102.

In other embodiments, the system 100 may be configured to receive the real-time information from the mobile device 108. The mobile device 108 may be configured to receive the real-time information from the source of information 112, thus serving as an interface between the system 100 and the source of information 112. Optionally, the mobile device 108 may collect the real-time information, thus acting as the source of information 112. The mobile device 108 may be configured to transmit the real time information to the system 100, where it may be received, for example, by the processor 102.

The mobile device 108 may additionally include an interface 114 configured to communicate with the system 100. The interface 114 may include a software application that enables the mobile device 108 to receive the real-time information from the source of information 112 and to receive information from the system 100.

The real-time information may be analyzed and compiled to create at least one data set including data related to the risk factor(s) relevant in determining a travel insurance risk. For example, the real-time information may be analyzed by the processor 102 which may create the data set.

The real-time information, or data extracted from the real-time information, may then be analyzed by the system 100 and may be compared with statistical data corresponding to the risk factor(s) to dynamically estimate an insurance risk. For example, the real-time information may be compared to a quantitative assessment of risks posed to a population by the risk factor(s). An insurance cost may then be rendered based on the estimated insurance risk. For example, the insurance risk may be correlated with stored information to determine an insurance cost. In these and other embodiments, the computer-readable medium of the system 100 may store computer-executable instructions that, when executed by the processor 102, cause the system to perform the insurance risk estimation and insurance cost determination using the data obtained from the real-time information. As a non-limiting example, the insurance risk and/or cost may be estimated using an algorithm stored on the computer-readable medium. An insurance policy including contract conditions related to the travel itinerary may be created based on the estimated risk and/or cost.

The estimated insurance risk and/or cost may be altered in response to at least one change in the real-time information. For example, the change in the real-time information may occur as a result of a change in the travel itinerary. The real-time information including the change may be transmitted by the source of information 112 or the mobile device 108 and may be received by the system 100. The insurance risk and/or cost may be re-estimated to reflect the change. The insurance cost may be assessed by the system 100 at the end of travel, thus, preventing unnecessary insurance costs by basing the insurance cost on the real-time information.

An individual may also make alterations to the real-time information based on changes in the travel itinerary. For example, the individual may plan an additional activity or change a route or duration of travel. The alteration may be transmitted to the system 100 and the insurance risk and/or cost may be modified to provide an insurance policy covering the alteration.

Using the real-time information may therefore enable an insurance provider to optimize the insurance policy by reducing the insurance risk and/or cost or to tailor the insurance policy to reflect changes in the travel itinerary. The system 100 may alternately or additionally be configured to optimize the insurance policy by determining at least one modification to the real-time in formation that results in a substantial reduction in the insurance cost.

The insurance costs may be assessed as a subscription fee paid on an annual or monthly or periodic basis regardless of whether an insured individual engages in travel. Alternately, the insurances costs may be assessed as a per trip fee determined as a function of the real-time information. Upon completion of a trip, a charge may be issued for a total cost of the insurance determined based on the real-time information collected during the trip.

By gathering and monitoring real-time information related to the travel itinerary, the system 100 enables estimating insurance costs for particular activities, or so-called “ad hoc” options, selected during travel. Such ad hoc options may include, for example, a helicopter, hot air balloon or motor cycle rides, skiing, hang gliding, a bicycle trip, scuba diving, excursions to neighboring countries, car rental, etc.

The system 100 may be configured to generate an electronic message including information related to the insurance policy. The electronic message may be transmitted to an individual or to a third-party insurance provider (not shown) by the system 100. The electronic message may include, for example, information related to the insurance risk (e.g., an insurance risk score), the insurance cost, or suggested alterations for optimizing the insurance policy. The electronic message may also include information functioning as an alert of a high insurance risk and/or cost associated with the travel itinerary. For example, if the insurance risk or cost determined for a particular location exceeds a predetermined level, the electronic message may be generated by the system 100 and transmitted to the mobile device 108. The electronic message may be made accessible to an individual by the interface 114 on the mobile device 108.

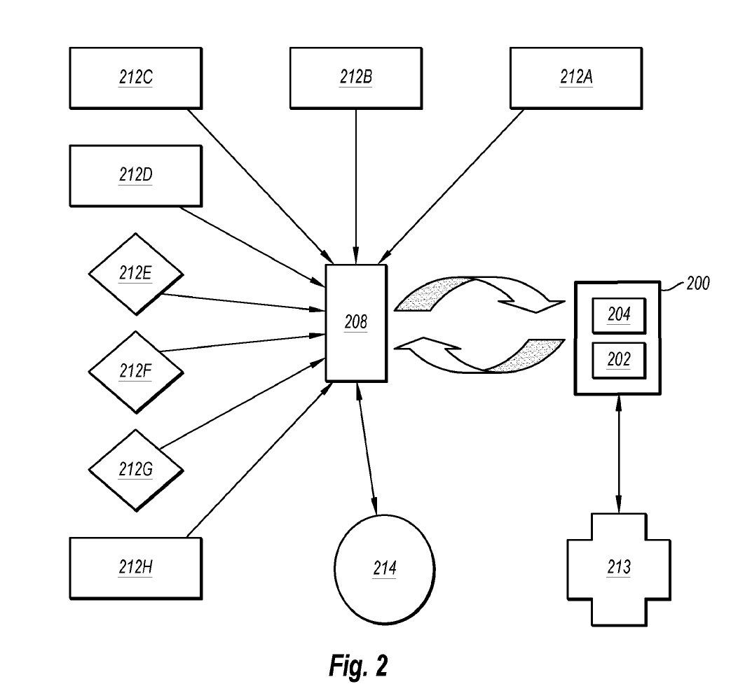

FIG. 2 is a block diagram illustrating another embodiment of a system 200 configured to estimate insurance risks and costs based on monitoring of real-time information, arranged in accordance with at least some embodiments described herein. The system 200 may be configured to render real-time data related to a travel itinerary into insurance risk and cost estimates. In the illustrated embodiment, the system 200 may include a processor 202 and a database 204. The processor 202 and the database 204 may respectively correspond to the processor 102 and the database 104 of FIG. 1, for example. The estimated insurance risk and cost may be used to generate a travel insurance policy including contract conditions defined by the real-time information. The system 200 may also be configured to determine “ad hoc” options that an insured individual would otherwise purchase separately from the contract conditions of the travel insurance policy. The ad hoc options may be added to a final cost of the insurance policy. The system 200 may further be configured to optimize the insurance policy by providing alternate options, such as, alternate routes, activities, travel dates and modes of transportation.

For example, the real-time information may be gathered by a mobile device 208 in communication with at least one of multiple sources of information 212A, 212B, 212C, 212D, 212E, 212F, 212G and 212H. The mobile device 208 may include, for example, a mobile telephone, a laptop computer, a desktop computer or a PDA. The real-time information obtained by the sources of information 212A, 212B, 212C, 212D, 212E, 212F, 212G and 212H may be transmitted to the mobile device 208 by at least one communication network (not shown). The communication network may include, for example, a telecommunications network, a global network, a national network, a local network, a LAN, a WAN, a PAN, a WLAN and/or a WPAN.

The source of information 212A may include a VICS service or a traffic information broadcast system and the real-time information collected may include, for example, at least one of traffic conditions and local population density. The source of information 212B may include a radio-clock and the real-time information may include, for example, the time and the date. The source of information 212C may include a GPS unit and the real-time information collected may include, for example, at least one of a location, a route and an average speed of travel. The source of information 212D may include a base station associated with a wireless telephone network and the real-time information collected may include, for example, at least one of a location and a local population density. The source of information 212E may include a weather sensor (e.g., a barometer and/or a thermometer) and the real-time information collected may include, for example, weather conditions. The source of information 212F may include an accelerometer and the real-time information collected may include, for example, physical acceleration of an object. The source of information 212G may include an altimeter and the real-time information collected may include an altitude. The source of information 212H may be a vehicle type or vehicle identification broadcast, such as an RFID system) and the real-time information collected may include, for example, a mode of transportation.

The mobile device 208 may be configured to transmit the real-time information obtained from the sources of information 212A, 212B, 212C, 212D, 212E, 212F, 212G and 212H to the processor 202 or the database 204. The real-time information may be analyzed using an algorithm 213 to render an insurance risk estimate and/or cost. The algorithm 213 may be stored on the same computer-readable medium as the database 204 or stored on a separate computer-readable medium.

The mobile device 208 may also be in communication with an insurance provider 214. For example, the estimated insurance risk and/or cost may be transmitted to the insurance provider 214 from the system 200 by the mobile device 208. The information provided by the system 200 may enable the insurance provider 214 to periodically assess a basic fee as well as offer ad hoc insurance options.

The processor 202 may analyze the real-time information to determine at least one ad hoc option for an additional contract condition outside the contract conditions of the original insurance policy. For example, the processor 202 may generate an electronic message including information related to the ad hoc option and may transmit the electronic message to the mobile device 208. As a non-limiting example, the additional contract condition may cover an additional activity selected during travel, such as, a helicopter, hot air balloon or motor cycle rides, skiing, hang gliding, a bicycle trip, scuba diving, excursions to a neighboring country, car rental, etc. As another non-limiting example, the additional contract condition may be determined based on information in the database 204 to reduce the estimated insurance risk and/or cost, or to optimize the travel itinerary.

An electronic message providing an alert based on the estimated insurance cost and/or risk may also be generated. For example, if the risk or cost is above a predetermined threshold, the processor may generate the electronic message to alert the individual or the insurance provider 214 of the potential risk or cost associated with the travel itinerary.

The systems 100 and 200 respectively described with respect to FIGS. 1 and 2 may utilize existing communication networks and sources of real-time information (such as GPS, radio-synchronized clocks and sensors) to provide a dynamic, real-time estimation of risks and calculation of associated insurance costs. The systems 100 and 200, may thereby enable tailoring of insurance costs based on information obtained by tracking an entire route or a portion of a route during travel. Such systems 100 and 200 may also enable selection of additional insurance options and/or conversely modification of the travel itinerary to reduce the insurance costs.

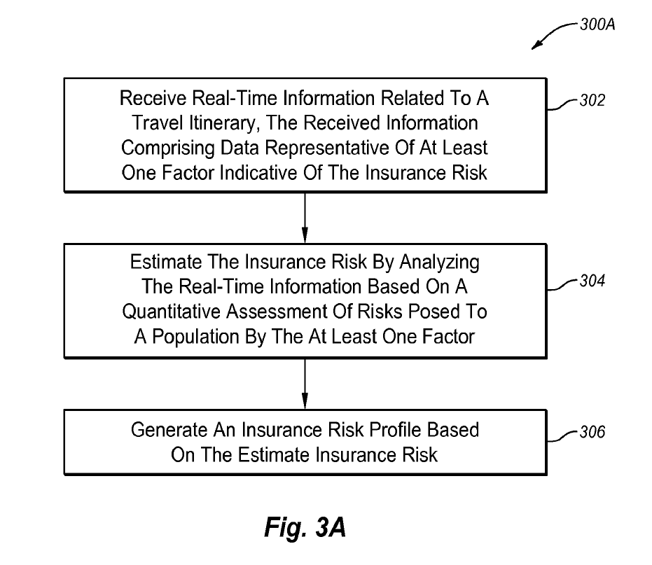

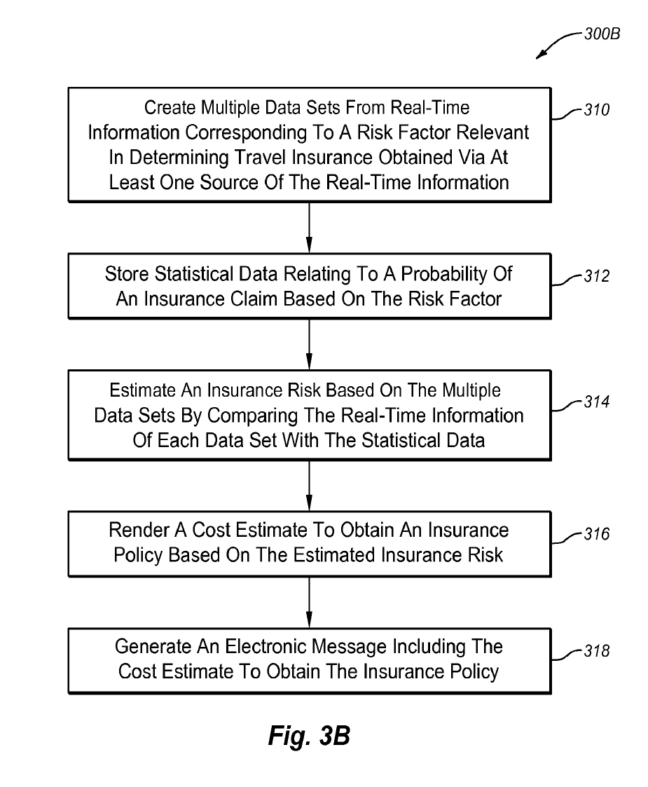

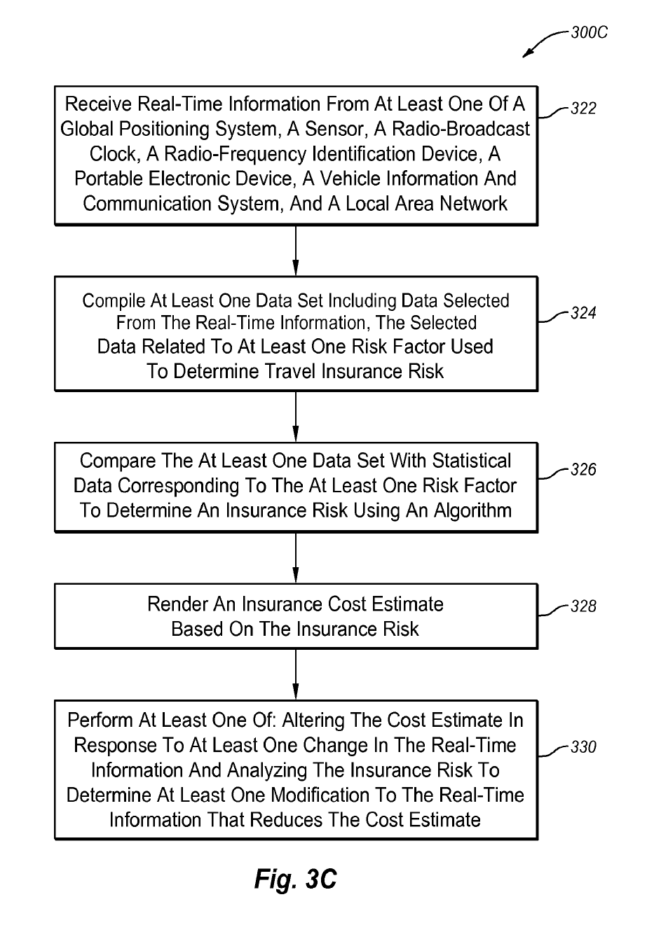

FIG. 3A shows an example flow diagram of a method 300A for estimating an insurance risk, arranged in accordance with at least some embodiments described herein. The insurance risks and costs discussed may relate to a traveler's insurance services (e.g., medical and dental expenses, emergency evacuation, trip cancelation or delays, death or injury, life, theft, damage loss, or theft of belongings, delayed baggage and automobile accidents or damage) for general or specialized tourism (e.g., motor vehicle, helicopter travel, ski, scuba diving, hot air balloon travel, hang gliding or paragliding, etc.).

The method 300A may be performed in whole or in part by the system 100 of FIG. 1 or the system 200 of FIG. 2. The method 300A includes various operations, functions or actions as illustrated by one or more of blocks 302, 304 and/or 306. The method 300A may begin at block 302.

In block 302, real-time information related to a travel itinerary is received, the received information including data representative of at least one factor indicative of the insurance risk. For example, the real-time information may be received by the processor 102 of FIG. 1 or the processor 202 of FIG. 2. The real-time information may be acquired through a global/national network (e.g., GPS, a radio-broadcast clock, etc.), sensors (e.g., altimeter, barometer, temperature gauge, visible light sensor, etc.), a LAN or PAN (e.g., vehicle type, VICS, a cellular phone base station, etc.) or a local network (e.g., RFID, BT, WLAN, etc.) for broadcasting vehicle type data during travel. For example, the real-time information may be collected by a portable electronic device configured to track and record information related to the travel itinerary. By way of example and not limitation, the portable electronic device may be a mobile telephone, a tablet device, a laptop computer, a PDA, a GPS unit, a navigation unit, a toll box, or an emergency remote.

Alternately or additionally, receiving real-time information related to a travel itinerary may include actively checking multiple sources of the real-time information to determine at least one change in the data representative of the at least one factor and updating the real-time information. Block 302 may be followed by block 304.

In block 304, the insurance risk may be estimated by analyzing the real-time data based on a quantitative assessment of risks posed to a population by the at least one factor. The data may be compiled, for example, by the processor 102 of the system 100 of FIG. 1 or the processor 202 of the system 200 of FIG. 2. The quantitative assessment of risks posed to a population by the at least one factor may be stored, for example, in the database 104 of FIG. 1 or the database 204 of FIG. 2.

In these and other embodiments, estimating the insurance risk by analyzing the real-time information based on a quantitative assessment of risks posed to a population by the at least one factor may include correlating statistical data stored on the database with the real-time information. Alternately or additionally, estimating the insurance risk by correlating statistical data on the database with the real-time information may include correlating the stored statistical data to calculate a score indicative of a level of risk posed by the travel itinerary based on the real-time information. Block 304 may be followed by block 306.

In block 306, an insurance risk profile may be generated based on the estimated insurance risk. As a non-limiting example, the insurance risk may be estimated by the processor 102 of FIG. 1 or the processor 202 of FIG. 2. In some embodiments, the insurance risk may be estimated using an algorithm stored on the computer-readable medium or otherwise accessible to the processor 102 or 202.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, although not shown in FIG. 3A, the method 300A may further include determining at least one alteration to the travel itinerary that reduces the estimated insurance risk based on the quantitative representation, or determining at least one modification in the travel itinerary that results in a substantially reduced insurance risk. The method 300A may additionally include generating an electronic message including information related to the at least one alteration or modification. In some embodiments, the at least one alteration or modification may be determined by the processor 102 or 202 of FIG. 1 or 2, and/or the electronic message may be generated by the processor 102 or 202.

Alternately or additionally, the method 300A may additionally include tracking a route of an individual to obtain the real-time information. In some embodiments where the individual is carrying the mobile device 108 or 208 of FIG. 1 or 2, the route of the individual may be tracked by periodically receiving location data from the mobile device 108 or 208, for example. The location data itself may represent real-time information that may be used as described herein to estimate the insurance risk, for example.

FIG. 3B shows an example flow diagram of a method 300B for estimating an insurance cost, arranged in accordance with at least some embodiments described herein. The method 300B may be performed in whole or in part by the system 100 of FIG. 1 or the system 200 of FIG. 2. The method 300B includes various operations, functions or actions as illustrated by one or more of blocks 310, 312, 314, 316 and/or 318. The method 300B may begin at block 310.

In block 310, multiple data sets are created from real-time information corresponding to a risk factor relevant in determining travel insurance obtained via at least one source of the real-time information. For example, data sets may be created from the real-time information by the processor 102 of FIG. 1 or the processor 202 of FIG. 2. Block 310 may be followed by block 312.

In block 312, statistical data relating to a probability of an insurance claim based on the risk factor may be stored. The statistical information may be stored, for example, by the database 104 of FIG. 1 or the database 204 of FIG. 2. Block 312 may be followed by block 314.

In block 314, an insurance risk may be estimated based on the multiple data sets by comparing the real-time information of each data set with the statistical data. As a non-limiting example, the insurance risk may be estimated by the processor 102 of FIG. 1 or by the processor 202 of FIG. 2. Estimating the insurance risk may include using an algorithm, such as algorithm 213 of FIG. 2. Block 314 may be followed by block 316.

In block 316 an insurance cost estimate may be rendered to obtain an insurance policy based on the estimated risk. For example, the processor 102 of FIG. 1 or the processor 202 of FIG. 2 may render the cost estimate. Block 316 may be followed by block 318.

In block 318 an electronic message may be generated that includes the cost estimate to obtain the insurance policy. For example, the electronic message may be generated by the processor 102 of FIG. 1 or the processor 202 of FIG. 2.

Although not illustrated in FIG. 3B, the method 300B may further include monitoring the at least one source of the real-time information to determine an alteration in the real-time information. At least one of the multiple data sets may be revised to include the altered real-time information. The insurance risk may then be re-estimated based on the multiple data sets by comparing the altered real-time information with the statistical data stored in the database. In these and other embodiments, monitoring the at least one source of the real-time information may include monitoring the at least one source of the real-time information via an Internet connection. Alternately or additionally, the alteration in the real-time information may occur as a result of a change in a travel itinerary.

FIG. 3C shows an example flow diagram of a method 300C for determining insurance cost, arranged in accordance with at least some embodiments described herein. The method 300C may be performed in whole or in part by the system 100 of FIG. 1 or the system 200 of FIG. 2. The method 300C includes various operations, functions or actions as illustrated by one or more of blocks 322, 324, 326, 328 and/or 330. The method 300C may begin at block 322.

In block 322, real-time information is received from at least one of a global positioning system, a sensor, a radio-broadcast clock, a radio-frequency identification device, a portable electronic device, a vehicle information and communication system and a local area network. For example, the real-time information may be received by the processor 102 of FIG. 1 or the processor 202 of FIG. 2. The real-time information may include, for example, at least one of a specific location, a travel season, a travel time, a travel date, a travel route, travel activity, weather, vehicle type, vehicle condition, traffic accident rate, traffic conditions, local population density, local transportation, altitude, and transportation mode. Block 322 may be followed by block 324.

In block 324, at least one data set may be compiled that includes data selected from the real-time information. The selected data may be related to at least one risk factor used to determine travel insurance risk. The at least one data set may be compiled by, for example, the processor 102 of FIG. 1 or the processor 202 of FIG. 2. Block 324 may be followed by block 326.

In block 326, the at least one data set may be compared with statistical data corresponding to the at least one risk factor to determine an insurance risk using an algorithm. As a non-limiting example, the statistical data may be calculated based on a probability of an insurance claim related to the at least one risk factor to determine the insurance risk. As a non-limiting example, the at least one data set may be compared with the statistical data by the processor 102 of FIG. 1 or by the processor 202 using the algorithm 213 of FIG. 2. Block 326 may be followed by block 328.

In block 328, an insurance cost estimate may be rendered based on the insurance risk. For example, the insurance cost may be estimated by the processor 102 of FIG. 1 or the processor 202 of FIG. 2. Block 328 may be followed by block 330.

In block 330, the cost estimate may be altered in response to at least one change in the real-time information and/or the insurance risk may be analyzed to determine at least one modification to the real-time information that reduces the cost estimate.

Although not shown in FIG. 3C, the method 300C may additionally include generating an electronic message including the cost estimate. The electronic message may be sent to a corresponding insured individual or individual seeking insurance.

Alternately or additionally, the method 300C may further include tracking a travel route of at least one individual to obtain the real-time information.

Alternately or additionally, the method 300C may further include generating a message including a notification that at least one of the insurance risk or the cost estimate exceeds a predetermined level. The message may be sent to the corresponding insured individual or individual seeking insurance. In response to the message, the individual may, for example, alter a travel itinerary or travel activities, or the like.

Some embodiments disclosed herein include a computer-readable storage medium having computer-executable instructions stored thereon that are executable by a processor to cause a computer to perform any one or more of the methods 300A, 300B, 300C of FIGS. 3A-3C, and/or variations thereof. The computer-readable storage medium may be included in, e.g., the system 100, 200 of FIGS. 1-2.

The methods 300A, 300B and 300C enable insurance costs to be optimized dynamically optimize depending on any number of factors related to travel insurance, such as, a specific location, season, time, activity, weather, local population density, mode of transportation, vehicle type, etc. Thus, reduced insurance costs and expanded opportunities (e.g., traveling to areas not originally included in the travel itinerary) may be provided. The insurance may be provided on the basis of an annual or continuous subscription fee and/or a basic fee per trip determined by country, duration and/or number of persons.

The methods 300A, 300B and 300C also enable insurance providers to offer services that periodically assess a basic fee on a continuous basis, as well as offering ad hoc insurance options to prevent purchase of separate insurance outside the original travel insurance contract conditions. The methods 300A, 300B and 300C increase convenience of obtaining insurance by enabling insurance providers to tailor insurance policies for particular travel itineraries. By facilitating continuous service contracts and providing additional contract provisions, the methods 300A, 300B and 300C provide increased revenues per individual.

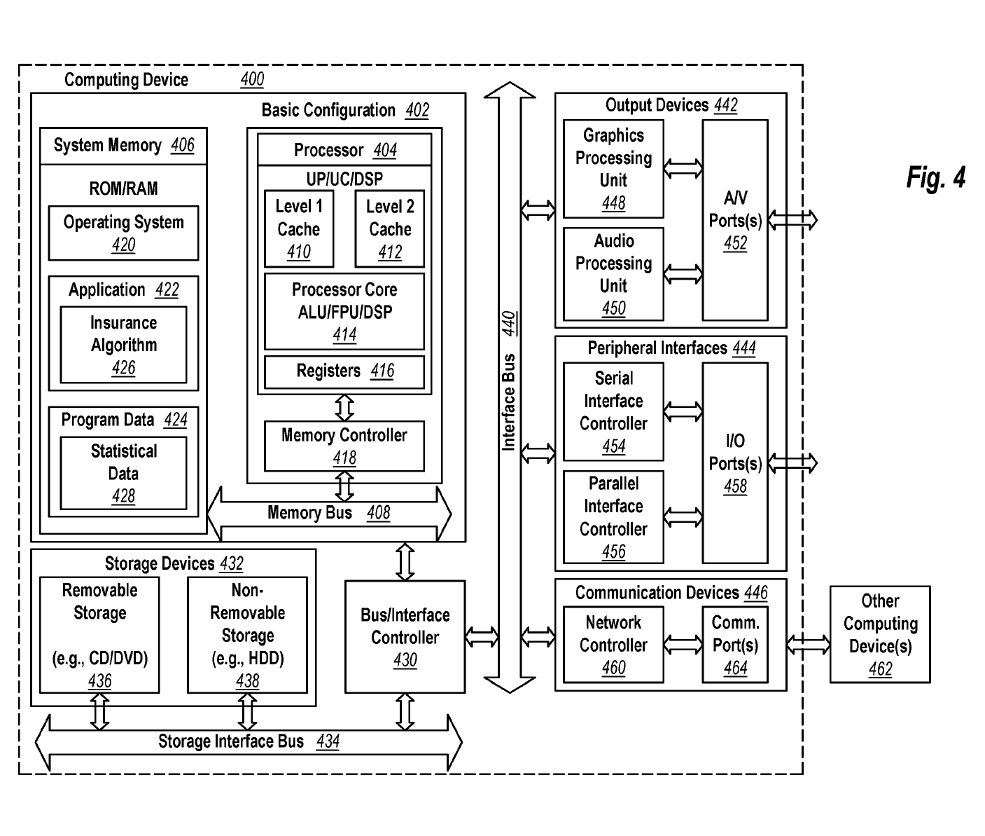

FIG. 4 is a block diagram illustrating an example computing device 400 that is arranged for estimating insurance risks and costs in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414 and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include an insurance algorithm 426 configured to estimate insurance risks and/or costs that is arranged to perform the functions described herein including those described with respect to the method 300 of FIG. 3. Program data 424 may include statistical data 428 that may be useful for estimating insurance risks and/or costs as is described herein. In some embodiments, application 422 may be arranged to operate with program data 424 on operating system 420 such that insurance risks and/or costs may be estimated dynamically based on real-time information as described herein. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for estimating a risk during travel, comprising:
receiving, by a processor during the travel, real-time information related to an itinerary of the travel, the received real-time information comprising data representative of at least one factor indicative of the risk during the travel;
estimating, by the processor, the risk by analyzing the real-time information based on a quantitative assessment of risks posed to a population by the at least one factor; and
generating, by the processor, a risk profile based on the estimated risk.

2. The method of claim 1, wherein receiving the real-time information related to the itinerary of the travel comprises receiving the real-time information from at least one of a global positioning system, a sensor, a radio-broadcast clock, a radio-frequency identification device, a portable electronic device, a vehicle information and communication system, and a local area network.

3. The method of claim 1, wherein receiving the real-time information related to the itinerary of the travel comprises receiving the real-time information from a sensor to determine at least one of altitude, humidity, temperature, and visible light.

4. The method of claim 1, wherein the real-time information related to the itinerary of the travel comprises real-time information related to at least one of a location, time, date, duration, season, weather, population density, vehicle type, and travel route.

5. The method of claim 1, wherein receiving the real-time information related to the itinerary of the travel comprises receiving the real-time information from a software application on a mobile device.

6. The method of claim 1, wherein estimating the risk by analyzing the real-time information comprises estimating the risk using an algorithm accessible by the processor.

7. The method of claim 1, wherein estimating the risk by analyzing the real-time information based on a quantitative assessment of risks posed to a population by the at least one factor comprises estimating the risk by correlating statistical data stored on the database with the real-time information.

8. The method of claim 7, wherein estimating the insurance risk by correlating the statistical data stored on the database with the real-time information comprises correlating the stored statistical data to calculate a score indicative of a level of risk posed by the itinerary of the travel based on the real-time information.

9. The method of claim 1, further comprising storing statistical data corresponding to the at least one factor indicative of the risk on the database.

10. The method of claim 1, wherein receiving the real-time information related to the itinerary of the travel comprises actively checking a plurality of sources of the real-time information to determine at least one change in the data representative of the at least one factor and updating the real-time information.

11. The method of claim 1, further comprising:
determining, by the processor, at least one alteration to the itinerary of the travel that reduces the estimated risk based on the quantitative representation; and
generating, by the processor, an electronic message comprising information related to the at least one alteration.

12. The method of claim 1, further comprising:
determining at least one modification in the itinerary of the travel that results in a substantially reduced risk; and
generating an electronic message comprising information related to the at least one modification.

13. The method of claim 1, further comprising tracking a route of an individual to obtain the real-time information.

14. A computer-readable storage medium having computer-executable instructions stored thereon that are executable by a processor to cause a computer to perform the method of claim 1.

15. A method for estimating an insurance cost during travel, comprising:
creating, by a processor during the travel, a plurality of data sets from real-time information obtained during the travel via at least one source of the real-time information, wherein the real-time information corresponds to a risk factor relevant in determining insurance;
estimating, by the processor, a risk based on the plurality of data sets by comparing the real-time information of each data set obtained during the travel with statistical data relating to a probability of an insurance claim based on the risk factor;
estimating a cost to obtain an insurance policy based on the estimated risk; and
generating an electronic message including the cost estimate to obtain the insurance policy.

16. The method of claim 15, further comprising:
monitoring the at least one source of the real-time information to determine an alteration in the real-time information occurring during the travel;
revising at least one of the plurality of data sets to include the altered real-time information; and
re-estimating the insurance risk based on the plurality of data sets by comparing the altered real-time information with the statistical data stored on the database.

17. The method of claim 15, wherein monitoring the at least one source of the real-time information comprises monitoring, by the processor, the at least one source of the real-time information via an Internet connection.

18. The method of claim 15, wherein creating a plurality of data sets from the real-time information comprises creating the plurality of data sets from real-time information comprising at least one of a location, a travel season, a travel time, a travel date, a travel route, travel activity, weather, vehicle type, vehicle condition, traffic accident rate, traffic conditions, local population density, local transportation, altitude, and transportation mode.

19. (canceled)

20. The method of claim 15, further comprising enabling access to the processor such that the real-time information may be updated based on at least one change in the real-time information occurring as a result of a change in the itinerary of the travel.

21. The method of claim 15, further comprising obtaining the real-time information corresponding to the risk factor relevant in determining the travel insurance from at least one of a global positioning system, a sensor, a radio-broadcast clock, a radio-frequency identification device, a portable electronic device, a vehicle information and communication system, and a local area network.

22.-33. (canceled)

34. A system for estimating a risk during travel, comprising:
a processor; and
a memory operatively coupled to the processor;
wherein the processor is configured to:
receive real-time information related to an itinerary of the travel, the received real-time information comprising data representative of at least one factor indicative of the risk during the travel;
estimate the risk by analyzing the real-time information based on a quantitative assessment of risks posed to a population by the at least one factor; and
generate a risk profile based on the estimated risk.

35. The system of claim 34,
wherein the processor is further configured to store the received real-time information in the memory; and
wherein the analyzing of the real-time information in the estimate of the risk includes retrieving from the memory at least some of the real-time information and an algorithm used in the analyzing.

36. The system of claim 34,
wherein the processor is further configured to automatically and dynamically determine ad hoc changes to an existing insurance policy based on the generated risk profile.

37. The system of claim 36,
wherein the processor is further configured to cause output of an electronic message related to the determining of ad hoc changes to the existing insurance policy.

38. The system of claim 37,
wherein an ad hoc change must at least meet a predetermined change threshold to be output.

39. A system for estimating a risk during travel, comprising:
a processor; and
a memory operatively coupled to the processor;
wherein the processor is configured to:
receive real-time information related to an itinerary of the travel, the received real-time information comprising data representative of at least one factor indicative of the risk during the travel;
estimate the risk by analyzing the real-time information based on a quantitative assessment of risks related to the at least one factor; and
estimate an insurance policy based on the estimated risk.

40. The system of claim 39,
wherein the estimate of an insurance policy includes an estimate of cost of the insurance policy on a risk-by-risk basis.

41. The system of claim 39,
wherein the estimate of the insurance policy includes automatically and dynamically determining ad hoc changes to an existing insurance policy based on the estimated risk.

42. The system of claim 41,
wherein the processor is further configured to cause output of an electronic message related to the determining of ad hoc changes to the existing insurance policy.

43. The system of claim 42,
wherein an ad hoc change must at least meet a predetermined cost change threshold to be output.
